(19) United States
(12) Patent Application Publication
(10) Pub. No.: US 2008/0280797 A1
(43) Pub. Date: Nov. 13, 2008

(54) Composition for caring for and/or removing makeup from keratinous substance(s)

(75) Inventor: Delphine Compain, Paris (FR)

Correspondence Address: OLIFF & BERRIDGE, PLC, P.O. BOX 320850, ALEXANDRIA, VA, 22320-4850, US

(73) Assignee: L'OREAL, PARIS (FR)

(21) Appl. No.: 12/149,164

(22) Filed: Apr. 28, 2008

Related U.S. Application Data
(60) Provisional application No. 60/944,803, filed on Jun. 19, 2007.

(30) Foreign Application Priority Data
Apr. 27, 2007 (FR) 07 54749

(51) Int. Cl. C11D 3/20

(52) U.S. Cl. 510/136

(57) ABSTRACT

A cosmetic product for cleansing and/or removing makeup from keratinous substance(s) includes, separately from one another, at least a first and a second cosmetic composition. The first composition is in the form of an oil-in-water emulsion obtained according to the phase inversion temperature process according to PIT technology and includes, in a physiologically acceptable medium, at least 50% by weight of at least one oil or oily phase, relative to the total weight of the first composition. The second composition is in the form of an aqueous gel and includes, in a physiologically acceptable medium, at least one foaming surfactant.

This non provisional application claims the benefit of French Application No. 07 54749 filed on Apr. 27, 2007 and U.S. Provisional Application No. 60/944,803 filed on Jun. 19, 2007.

### BACKGROUND

The present invention aims to provide compositions intended, more particularly for caring for and/or removing makeup from keratinous substances.

The cleansing of keratinous substances, and more particularly the skin, is very important. Thus, on the face for example, it must be as effective as possible since greasy residues, such as excess sebum, and the residues of cosmetic products used daily, such as makeup products, have a tendency to accumulate in the skin folds and on the surface of the skin. They may thus block the pores of the skin and lead to the appearance of spots.

Conventional skin-cleansing products can be divided into three main families:
foaming detergent aqueous gels and lotions,
makeup-removing milks and creams; and
rinsable cleansing anhydrous gels and oils.

The foaming detergent aqueous gels and lotions have an effective cleansing action due to the surfactants that they contain. They are, in addition, cosmetically agreeable due to the fact that they foam and that they are easily removed. However, insofar as they do not contain cosmetic oils, they may have the drawback of drying the skin via their defatting action.

The makeup-removing milks and creams themselves contain, at the same time, oils, emulsifiers and detergent surfactants, the latter being in a sufficiently small amount so as not to destabilize the emulsion. Unfortunately, these products, despite their high efficacy, are not foaming and therefore have an insufficient rinsability. They generally require the joint use of a detergent lotion to perfect the rinsing.

Oily compositions are also recognized for their efficacy as cleansers and/or makeup removers. This is because they make it possible to very easily dissolve lipophilic dirt and makeup, especially transfer-resistant makeup that is reputedly difficult to remove. These products are effective and generally are well tolerated. They have, however, the drawback of not foaming and of not giving a feeling of freshness on application. As regards the oily compositions that have the appearance of a gel, they are generally thickened by waxes, silicas or else clays which give them a habitually cloudy or opaque, and therefore unattractive, appearance.

Consequently, there remains to date a need for a cleansing and/or makeup-removing product which combines the advantages of the oils or emulsified oils, especially in terms of innocuity and non-drying appearance, and those of the foaming gels, especially in terms of cleansing performance, without moreover reproducing their respective drawbacks.

### SUMMARY

Specifically, an object of the present invention is to provide a novel type of cleansing and/or makeup-removing product that makes it possible to give satisfaction in these terms.

Thus, the present invention mainly relates to a cosmetic product for cleansing and/or removing makeup from keratinous substance(s) comprising, separately from one another, at least a first and a second cosmetic composition, and wherein:
the first composition A comprises, in a physiologically acceptable medium, at least 50% by weight of at least one oil or oily phase, relative to the total weight of said first composition; and
the second composition B is in the form of an aqueous gel and comprises, in a physiologically acceptable medium, at least one foaming surfactant.

The product according to the invention may especially form a cleansing, makeup-removing product, a scrubbing product or an exfoliating product.

According to one embodiment variant, the first composition A is in the form of an emulsion, and more particularly an oil-in-water emulsion especially obtained according to the phase inversion temperature process according to Phase Inversion Temperature (PIT) technology.

According to another embodiment variant, the second composition B is in the form of a transparent aqueous gel.

According to another embodiment variant, the first and second compositions have similar viscosities.

According to one particular embodiment, the first and second compositions are packaged separately from one another, but are brought together in a single packaging unit.

According to another embodiment, the first and second compositions are packaged separately from one another in different packaging units.

Another subject of the present invention is a unit for packaging and dispensing compositions that form a product according to the invention, said unit comprising at least two independent compartments that respectively comprise each of said compositions and that are adjusted for dispensing the two compositions separately or as a mixture.

According to one embodiment variant, the mixing of the compositions is carried out within said unit just before use and therefore before application to at least one keratinous substance.

According to another embodiment variant, the mixing of the two compositions is carried out extemporaneously outside of said unit either onto a dedicated cleansing and/or makeup-removing support, such as a cotton pad for example, or directly onto the keratinous substance that should be the subject of the cleansing and/or makeup-removing operation.

The present invention also relates, according to another of its aspects, to a method for cleansing and/or removing makeup from keratinous substance(s) comprising at least the steps consisting in:

a) having a first composition A that comprises, in a physiologically acceptable medium, at least 50% by weight of at least one oil or oily phase relative to the total weight of said first composition;

b) having a second composition B that is in the form of an aqueous gel and that comprises, in a physiologically acceptable medium, at least one foaming surfactant;

c) bringing said first composition A into contact extemporaneously with said second composition B; and

d) applying the mixture obtained in the preceding step to said keratinous substance.

According to one embodiment variant, steps c) and d) are carried out simultaneously.

According to another embodiment variant, step d) is carried out in the presence of water.

Where appropriate, step d) may advantageously be followed by a step of rinsing the keratinous substance thus treated with water.

More particularly, said keratinous substance is the skin or the hair.

More preferably, it is the skin.

The product according to the present invention proves particularly advantageous insofar as it makes it possible to combine the respective advantages of conventional cleansing and/or makeup compositions while being free from their respective drawbacks.

Its makeup-removing and/or cleansing performance proves significantly increased in comparison to a single conventional composition.

In particular, this product, which only requires the two compositions forming it to be brought into contact at the moment of their use, that is to say extemporaneously, proves to be equipped with an improved foaming power relative to that observed with a single composition formed from the respective components of the first and second compositions according to the invention. In particular, the foam is creamier, whiter and has fine bubbles.

As specified previously, at least one of the compositions forming the product according to the invention, also known as the first composition, comprises at least one oil or oily phase.

### BRIEF DESCRIPTION OF THE DRAWINGS

FIG. 1 shows a packaging unit.

### DETAILED DESCRIPTION OF EMBODIMENTS

First Composition A

The first composition A comprises at least 50% by weight of at least one oil or oily phase relative to its total weight.

It may especially comprise at least 55% by weight, for example at least 60% by weight, or even at least 65% by weight of at least one oil or oily phase relative to its total weight.

Within the meaning of the invention, the first composition A may comprise a single oil or a mixture of several oils denoted by the term oily phase.

The term “oil” is understood to mean a fatty substance that is liquid at ambient temperature (25° C.).

As oils that can be used in the composition of the invention, mention may be made, for example, of:
hydrocarbon-based oils of animal (fish) origin, such as perhydrosqualene and squalane;
hydrocarbon-based oils of vegetable origin, such as the liquid triglycerides of fatty acids comprising from 4 to 10 carbon atoms such as heptanoic or octanoic acid triglycerides or else, for example, sunflower oil, maize oil, soybean oil, marrow oil, grapeseed oil, sesame oil, hazelnut oil, apricot oil, macadamia oil, arara oil, castor oil, avocado oil, caprylic/capric acid triglycerides such as those sold by Stearineries Dubois or those sold under the names Miglyol 810, 812 and 818 by Dynamit Nobel, jojoba oil, and shea butter oil;
synthetic esters and ethers, especially the esters and ethers of fatty acids, such as the oils of formulae R¹COOR² and R¹OR² in which R¹ represents the residue of a fatty acid comprising from 8 to 29 carbon atoms, and R² represents a branched or unbranched hydrocarbon-based chain containing from 3 to 30 carbon atoms, such as, for example, Purcellin oil, isononyl isononanoate, isopropyl myristate, 2-ethylhexyl palmitate, 2-octyldodecyl stearate, 2-octyldodecyl erucate, isostearyl isostearate, and isononyl isononanoate; hydroxylated esters such as isostearyl lactate, octyl hydroxystearate, octyldodecyl hydroxystearate, diisostearyl malate, triisocetyl citrate, and the heptanoates, octanoates and decanoates of fatty alcohols; polyol esters, such as propylene glycol dioctanoate, neopentyl glycol diheptanoate and diethylene glycol diisononanoate; and esters of pentaerythritol such as pentaerythrityl tetraisostearate (Prisorine 3631);
linear or branched hydrocarbons of mineral or synthetic origin, such as volatile or non-volatile liquid paraffins and their derivatives, petroleum jelly, polydecenes, or hydrogenated polyisobutene such as parleam oil;
silicone oils, such as, for example, volatile or non-volatile polydimethylsiloxanes (PDMSs) having a linear or cyclic silicone-based chain, that are liquid or pasty at ambient temperature, especially cyclopolydimethylsiloxanes (cyclomethicones) such as cyclohexasiloxane and cyclopentasiloxane; polydimethylsiloxanes (or dimethicones) comprising alkyl, alkoxy or phenyl groups that are pendent or at the end of a silicone-based chain, groups that have from 2 to 24 carbon atoms; phenylsilicones such as phenyltrimethicones, phenyldimethicones, phenyltrimethylsiloxydiphenylsiloxanes, diphenyldimethicones, diphenylmethyldiphenyl-trisiloxanes, 2-phenylethyltrimethylsiloxysilicates, and polymethylphenylsiloxanes;
fatty alcohols having from 8 to 26 carbon atoms, such as cetyl alcohol, stearyl alcohol and their mixture (cetylstearyl alcohol);
partially hydrocarbon-based and/or silicone-based fluoro oils such as those described in document JP-A-2-295912; and
mixtures thereof.

The expression “hydrocarbon-based oil” is understood above to mean any oil that predominantly comprises carbon and hydrogen atoms, and optionally ester, ether, fluoro, carboxylic acid and/or alcohol groups.

According to one preferred embodiment of the invention, the composition A contains at least one oil chosen from hydrogenated polyisobutene (INCI name: Hydrogenated Polyisobutene or C13-16 Isoparaffin) such as the product sold under the name Parleam by NOF Corporation, and fatty acid esters such as, in particular, isononyl isononanoate, isopropyl myristate, 2-ethylhexyl palmitate, 2-octyldodecyl stearate, 2-octyldodecyl erucate, isostearyl isostearate and 2-ethylhexyl stearate.

The preferred oils are fatty alcohol esters such as 2-ethylhexyl palmitate and 2-ethylhexyl stearate.

This oil, or else oily phase, formed from one or more of the aforementioned oils, where appropriate as a mixture with other fatty substances and lipophilic constituents, may advantageously form the oily phase of an emulsion.

These emulsions may be of the oil-in-water type, water-in-oil type or else of multiple type.

Advantageously, these are oil-in-water emulsions.

According to one embodiment of the invention, the first composition A comprises at least one emulsifier.

These emulsions thus generally contain at least one surfactant especially chosen from amphoteric, anionic, cationic or nonionic emulsifiers, used alone or as a mixture. The emulsifiers are chosen, in an appropriate manner, depending on the continuous phase of the emulsion to be obtained (W/O or O/W). When the emulsion is a multiple emulsion, it generally comprises one emulsifier in the primary emulsion and one emulsifier in the external phase into which the primary emulsion is introduced.

As emulsifiers that can be used for preparing W/O emulsions, mention may be made, for example, of alkyl esters or ethers of sorbitan, of glycerol or of sugars; silicone-based surfactants such as dimethicone copolyols, for instance the mixture of cyclomethicone and dimethicone copolyol sold under the names DC 5225 C and DC 3225 C by Dow Corning, and such as alkyl dimethicone copolyols such as lauryl methicone copolyol sold under the name “Dow Corning 5200 Formulation Aid” by Dow Corning, cetyl dimethicone copolyol sold under the name Abil EM 90® by Goldschmidt and the mixture of polyglyceryl-4 isostearate/cetyl dimethicone copolyol/hexyl laurate sold under the name Abil WE 09® by Goldschmidt. It is also possible to add thereto one or more coemulsifiers, which, advantageously, may be chosen from the group comprising esters of a fatty acid having a branched chain and of a polyol, and especially the esters of a fatty acid having a branched chain and of glycerol and/or of sorbitan and, for example, polyglyceryl isostearate, such as the product sold under the name Isolan GI 34 by Goldschmidt, sorbitan isostearate, such as the product sold under the name Arlacel 987 by ICI, glycerol sorbitan isostearate, such as the product sold under the name Arlacel 986 by ICI, and mixtures thereof.

As emulsifiers that can be used for preparing O/W emulsions, mention may be made, for example, of nonionic emulsifiers such as the esters of fatty acids and of oxyalkylenated (more particularly polyoxyethylenated) polyols, and for example polyethylene glycol stearates such as PEG-100 stearate, PEG-50 stearate and PEG-40 stearate; and mixtures thereof such as the mixture of glyceryl monostearate and of polyethylene glycol (100 EO) stearate sold under the name SIMULSOL 165 by SEPPIC; the esters of fatty acids and of oxyalkylenated sorbitan comprising, for example, from 20 to 100 EO, and, for example, those sold under the trade names Tween 20 or Tween 60 by Uniqema; oxyalkylenated (oxyethylenated and/or oxypropylenated) fatty alcohol ethers; sugar esters such as sucrose stearate; and mixtures thereof such as, for example, the mixture of glyceryl stearate and of PEG-100 stearate, sold under the name Arlacel 165 by Uniqema.

It is also possible to add, to these emulsifiers, coemulsifiers such as, for example, fatty alcohols having from 8 to 26 carbon atoms, such as cetyl alcohol, stearyl alcohol and their mixture (cetearyl alcohol), octyldodecanol, 2-butyloctanol, 2-hexyldecanol, 2-undecylpentadecanol or oleyl alcohol.

It is also possible to prepare emulsions without emulsifying surfactants or that contain less than 0.5% of the total weight of the composition, using suitable compounds, for example polymers that have emulsifying properties such as the polymers sold under the names Carbopol 1342 and Pemulen by Noveon; or polymers and copolymers of 2-acrylamido-2-methylpropanesulfonic acid, optionally crosslinked and/or neutralized, such as poly(2-acrylamido-2-methylpropanesulfonic acid) sold by Clariant under the name “Hostacerin AMPS” (INCI name: ammonium polyacryldimethyltauramide) or such as the polymer in emulsion sold under the name SEPIGEL 305 by SEPPIC (INCI name: Polyacrylamide/C13-C14 isoparaffin/laureth-7); particles of ionic or nonionic polymers, more particularly particles of an anionic polymer such as, in particular, polymers of isophthalic acid or sulfoisophthalic acid, and in particular phthalate/sulfoisophthalate/glycol copolymers (for example, diethylene glycol/phthalate/isophthalate/1,4-cyclohexanedimethanol copolymers (INCI name: Diglycol/CHDM/Isophthalates/SIP Copolymer) sold under the names Eastman AQ polymer (AQ35S, AQ38S, AQ55S, AQ48 Ultra) by Eastman Chemical.

According to one advantageous embodiment, the emulsion is prepared by the phase inversion temperature technique (PIT emulsions). This technique makes it possible, in particular, to achieve an average size of the globules forming the oily phase that varies from 0.1 to 4 μm (100 to 4000 nm).

The principle of emulsification via phase inversion temperature (PIT) is well known to a person skilled in the art; it was described in 1968 by K. Shinoda (J. Chem. Soc. Jpn., 1968, 89, 435). It has been shown that this emulsification technique makes it possible to obtain fine stable emulsions (K. Shinoda and H. Saito, J. Colloid Interface Sci., 1969, 30, 258). This technology has been applied in cosmetics from 1972 by Mitsui et al. (“Application of the phase-inversion-temperature method to the emulsification of cosmetics”; T. Mitsui, Y. Machida and F. Harusawa, American. Cosmet. Perfum., 1972, 87, 33).

Emulsification via phase inversion is explained in detail in the work by T. Forster, W. von Rybinski, A. Wadle, Influence of microemulsion phases on the preparation of fine disperse emulsions, Advances in Colloid and Interface Sciences, 58, 119-149, 1995 cited here for reference.

The principle of this technique is the following: a W/O emulsion is prepared (introduction of the aqueous phase into the oily phase) at a temperature which must be above the phase inversion temperature of this system, that is to say the temperature at which the equilibrium between the hydrophilic and lipophilic properties of the emulsifier or emulsifiers used is reached; at high temperature, that is to say above the phase inversion temperature (>PIT), the emulsion is of the water-in-oil type and, during its cooling, this emulsion converts at the phase inversion temperature to become an oil-in-water type emulsion, and this by first passing through a state of microemulsion. This process makes it possible to easily obtain emulsions having a diameter which is generally less than 4 μm.

More specifically, the PIT emulsions may be obtained by a phase inversion process carried out as follows:
weighing all the constituents of the composition (apart from heat-sensitive raw materials if there are any) into a container;
homogenizing the mixture, for example by means of a Rayneri mixer at 350 rpm, and heating, while gradually increasing the temperature, by means of a water bath to a temperature greater than or equal to the phase inversion temperature T2, that is to say until a transparent or translucent phase is obtained (microemulsion or lamellar phase zone), then until a more viscous white phase is obtained which indicates that the inverse (W/O) emulsion has been obtained;
stopping the heating and maintaining the stirring until ambient temperature has been returned to, by passing through the phase inversion temperature T1, that is to say the temperature at which a fine O/W emulsion is formed; and
when the temperature has dropped below the phase inversion temperature zone (T1), optionally adding the heat-sensitive raw materials.

A stable O/W emulsion is obtained, the oil droplets of which are fine.

In the aforementioned process, the addition of raw materials that are not heat-sensitive, such as fillers such as silica, colorants, polymers, and fragrances is generally carried out at the end of the procedure.

In the microemulsion formation zone (translucent mixture) the hydrophilic and hydrophobic interactions are balanced as the tendency of the surfactant is to form both direct micelles and inverse micelles. By heating beyond this zone, a W/O emulsion (opaque white mixture) is formed since the surfactant favors the formation of a water-in-oil emulsion. Then, during cooling below the phase inversion zone, the emulsion becomes an O/W emulsion.

The emulsifying surfactants of the oil-in-water type commonly used have an HLB (hydrophilic lipophilic balance) ranging from 8 to 18. These emulsifiers, due to their amphiphilic structure, position themselves at the oily phase/aqueous phase interface, and thus stabilize the dispersed oil droplets.

The emulsifying system used in the first composition A according to the invention may comprise one or more emulsifiers whose solubility in the oil increases with the increase in temperature, emulsifiers that make it possible to obtain emulsions via phase inversion temperature. The HLB (hydrophilic lipophilic balance) of these emulsifiers ranges from 8 to 18 and preferably from 10 to 16, and these emulsifiers are chosen from ethoxylated fatty alcohols, ethoxylated fatty acids, partial glycerides of ethoxylated fatty acids, triglycerides of polyglycerolated fatty acids and ethoxylated derivatives thereof, and mixtures thereof.

The emulsifiers are preferably chosen from ethoxylated fatty alcohols or ethoxylated fatty acids having the formulae (I) and (II) below:

R—O—(CH₂—CH₂—O)ₘH (I)

R—COO—(CH₂—CH₂—O)ₘH (II)

where R is a saturated or unsaturated, linear or branched hydrocarbon-based chain having from 10 to 24 carbon atoms, and m is an integer ranging from 8 to 50.

As ethoxylated fatty alcohols, mention may be made, for example, of the addition products of ethylene oxide with lauryl alcohol, especially those comprising from 9 to 50 oxyethylenated groups (Laureth-9 to Laureth-50 in the INCI names); the addition products of ethylene oxide with behenyl alcohol, especially those comprising from 9 to 50 oxyethylenated groups (Beheneth-9 to Beheneth-50 in the INCI names); the addition products of ethylene oxide with cetearyl alcohol (a mixture of cetyl alcohol and stearyl alcohol), especially those comprising from 9 to 30 oxyethylenated groups (Ceteareth-9 to Ceteareth-30 in the INCI names); the addition products of ethylene oxide with cetyl alcohol, especially those comprising from 9 to 30 oxyethylenated groups (Ceteth-9 to Ceteth-30 in the INCI names); the addition products of ethylene oxide with stearyl alcohol, especially those comprising from 9 to 30 oxyethylenated groups (steareth-9 to Steareth-30 in the INCI names); the addition products of ethylene oxide with isostearyl alcohol, especially those comprising from 9 to 50 oxyethylenated groups (Isosteareth-9 to Isosteareth-50 in the INCI names); and mixtures thereof.

As ethoxylated fatty acids, mention may be made, for example, of the addition products of ethylene oxide with lauric, palmitic, stearic or behenic acids, and mixtures thereof, especially those comprising from 9 to 50 oxyethylenated groups such as the laurates of PEG-9 to PEG-50 (as INCI names: PEG-9 laurate to PEG-50 laurate); the palmitates of PEG-9 to PEG-50 (as INCI names: PEG-9 palmitate to PEG-50 palmitate); the stearates of PEG-9 to PEG-50 (as INCI names: PEG-9 stearate to PEG-50 stearate); PEG-9 to PEG-50 palmitostearates; the behenates of PEG-9 to PEG-50 (as INCI names: PEG-9 behenate to PEG-50 behenate); and mixtures thereof.

It is also possible to use mixtures of these oxyethylenated derivatives of fatty alcohols and fatty acids.

Preferably, the emulsifying system of a first composition of the invention, that is in the form of an emulsion obtained by the PIT technique, contains, as an emulsifier, at least one ethoxylated fatty alcohol, more particularly the ceteths, ceteareths, beheneths and mixtures thereof, and more particularly beheneth-10.

This emulsifying system may additionally contain one or more coemulsifiers. As coemulsifiers, mention may be made, for example, of fatty alcohols having 8 to 30 carbon atoms, such as, for example, cetyl alcohol, stearyl alcohol or behenyl alcohol; fatty acids having 8 to 30 carbon atoms, such as, for example, palmitic acid, stearic acid or behenic acid; fatty esters of glycerol, such as, for example, glyceryl stearate; oxyethylenated derivatives of these fatty alcohols, fatty acids and fatty esters of glycerol, comprising 2 to 8 ethylene oxide groups, and mixtures thereof.

The emulsifying system is present in an amount ranging from 2 to 20%, preferably from 3 to 16% and better still from 3 to 11% by weight relative to the total weight of the first composition.

The emulsifying system/lipophilic phase ratio may range, for example, from 0.04 to 0.2 and preferably from 0.06 to 0.18.

Second Composition B

As regards the second composition B, it is characterized, on the one hand, by the fact that it is in the form of an aqueous gel and, on the other hand, in that it contains at least one foaming surfactant.

According to one particular embodiment, this composition B is in the form of a transparent aqueous gel.

Within the meaning of the invention, the word “transparent” means that through a transparent bottle containing said second composition, it is possible to distinguish the characters printed on a page of newspaper placed behind this bottle.

The composition B contains at least one foaming surfactant. However, the composition A may optionally also contain one or more foaming surfactants which complement those present in the composition B.

As regards the definition of the foaming surfactant, reference may be made to the document “Encyclopedia of Chemical Technology, Kirk-Othmer”, volume 22, pages 333-432, 3rd edition 1979, Wiley Publishing, where the main types of surfactants known to a person skilled in the art are cited, as well as their function, in particular the fact of being foaming.

Preferably, these surfactants may be chosen from nonionic, anionic and amphoteric surfactants.

Nonionic Foaming Surfactants

The nonionic foaming surfactants may be chosen, in particular, from alkyl polyglucosides (APGs), oxyalkylenated glycerol esters, oxyalkylenated sugar esters, and mixtures thereof. These are preferably APGs.

1) As alkyl polyglucosides, use is preferably made of those containing an alkyl group that comprises from 6 to 30 carbon atoms and preferably from 8 to 16 carbon atoms, and that contains a glucoside group preferably comprising 1, 2 to 3 glucoside units. The alkyl polyglucosides may be chosen, for example, from decyl glucoside (alkyl-C9/C11-polyglucoside (1.4)) such as the product sold under the name Mydol 10® by Kao Chemicals or the product sold under the name Plantacare 2000 UP® by Cognis; caprylyl/capryl glucoside such as the product sold under the name Plantacare KE 3711® by Cognis; lauryl glucoside such as the product sold under the name Plantacare 1200 UP® by Cognis; coco glucoside such as the product sold under the name Plantacare 818 UP® by Cognis; caprylyl glucoside such as the product sold under the name Plantacare 810 UP® by Cognis; and mixtures thereof.

2) The oxyalkylenated glycerol esters are especially the polyoxyethylenated derivatives of glyceryl fatty acid esters and hydrogenated derivatives thereof. These oxyalkylenated glycerol esters may be chosen, for example, from hydrogenated and oxyethylenated glyceryl fatty acid esters such as PEG-200 hydrogenated glyceryl palmate sold under the name Rewoderm LI-S 80 by Goldschmidt; oxyethylenated glyceryl cocoates such as PEG-7 glyceryl cocoate sold under the name Tegosoft GC by Goldschmidt, and PEG-30 glyceryl cocoate sold under the name Rewoderm LI-63 by Goldschmidt; and mixtures thereof.

3) The oxyalkylenated sugar esters are especially the polyethylene glycol ethers of fatty acid and sugar esters. These oxyalkylenated sugar esters may be chosen, for example, from oxyethylenated glucose esters such as PEG-120 methyl glucose dioleate sold under the name Glucamate DOE 120 by Amerchol.

According to one preferred embodiment of the invention, the nonionic surfactant is an alkyl polyglucoside which may be chosen, in particular, from decyl glucoside, caprylyl/capryl glucoside, lauryl glucoside, coco glucoside, caprylyl glucoside, and mixtures thereof.

Anionic Surfactants

The anionic foaming surfactants may be chosen, in particular, from the anionic derivatives of proteins of vegetable origin or of silk proteins, phosphates and alkyl phosphates, carboxylates, sulfosuccinates, amino acid derivatives, alkyl sulfates, alkyl ether sulfates, sulfonates, isethionates, taurates, alkyl sulfoacetates, polypeptides, anionic derivatives of alkyl polyglucosides, and mixtures thereof.

1) The anionic derivatives of proteins of vegetable origin are protein hydrolyzates having a hydrophobic group, said hydrophobic group possibly being naturally present in the protein or being added by reaction of the protein and/or of the protein hydrolyzate with a hydrophobic compound. The proteins are of vegetable origin or are derived from silk, and the hydrophobic group may especially be a fatty chain, for example an alkyl chain comprising from 10 to 22 carbon atoms. As anionic derivatives of proteins of vegetable origin, mention may more particularly be made of apple, wheat, soybean or oat protein hydrolyzates comprising an alkyl chain having from 10 to 22 carbon atoms and salts thereof. The alkyl chain may especially be a lauryl chain and the salt may be a sodium, potassium and/or ammonium salt.

Thus, as protein hydrolyzates having a hydrophobic group, mention may be made, for example, of the salts of hydrolyzates of silk protein modified by lauric acid, such as the product sold under the name KAWA SILK by Kawaken; the salts of hydrolyzates of wheat protein modified by lauric acid, such as the potassium salt sold under the name Aminofoam W OR by Croda (INCI name: Potassium lauroyl wheat amino acids) and the sodium salt sold under the name PROTEOL LW 30 by SEPPIC (INCI name: sodium lauroyl wheat amino acids); the salts of hydrolyzates of oat protein comprising an alkyl chain having from 10 to 22 carbon atoms, and more particularly the salts of hydrolyzates of oat protein modified by lauric acid, such as the sodium salt sold under the name PROTEOL OAT (30% aqueous solution) by SEPPIC (INCI name: Sodium lauroyl oat amino acids); the salts of hydrolyzates of apple protein, comprising an alkyl chain having from 10 to 22 carbon atoms, such as the sodium salt sold under the name PROTEOL APL (30% hydroglycolic solution) by SEPPIC (INCI name: Sodium Cocoyl Apple amino acids). Mention may also be made of the mixture of lauroyl amino acids (aspartic acid, glutamic acid, glycine, alanine) neutralized with sodium N-methylglycinate, sold under the name PROTEOL SAV 50 S by SEPPIC (INCI name: Sodium Cocoyl amino acids).

2) As phosphates and alkyl phosphates, mention may be made, for example, of monoalkyl phosphates and dialkyl phosphates, such as lauryl monophosphate sold under the name MAP 20® by Kao Chemicals, the potassium salt of dodecylphosphoric acid, as a mixture of monoester and diester (mainly diester) sold under the name CRAFOL AP-31® by Cognis, the mixture of octylphosphoric acid monoester and diester sold under the name CRAFOL AP-20® by Cognis, and the mixture of ethoxylated (7 mol of EO) 2-butyloctanol phosphoric acid monoester and diester sold under the name ISFOL 12 7 EO-PHOSPHATE ESTER® by Condea, the potassium or triethanolamine salt of mono(C₁₂-C₁₃)alkyl phosphate sold under the references ARLATONE MAP 230K-40-® and ARLATONE MAP 230T-60® by Uniqema, potassium lauryl phosphate sold under the name DERMALCARE MAP XC-99/09® by Rhodia Chimie, and potassium cetyl phosphate sold under the name ARLATONE MAP 160K by Uniqema.

3) As carboxylates, mention may be made of:
Amido ether carboxylates (AECs), such as sodium lauryl amido ether carboxylate (3 EO), sold under the name AKYPO FOAM 30® by Kao Chemicals.
Polyoxyethylenated carboxylic acid salts, such as oxyethylenated (6 EO) sodium lauryl ether carboxylate (62/25/10 C₁₂₋₁₄₋₁₆) sold under the name AKYPO SOFT 45 NV® by Kao Chemicals, polyoxyethylenated and carboxymethylated fatty acids of olive oil origin sold under the name OLIVEM 400® by Biologia E Tecnologia, oxyethylenated (6 EO) sodium tridecyl ether carboxylate sold under the name NIKKOL ECTD-6NEX® by Nikkol.
Fatty acid salts having a C₆ to C₂₂ alkyl chain, neutralized by an organic or inorganic base, which forms soaps. The fatty acid salt or soap is obtained from a fatty acid and a base, the fatty acid comprising a saturated or unsaturated, linear or branched alkyl chain having from 12 to 22 carbon atoms and preferably from 12 to 20 carbon atoms. The bases (also called saponifiers) completely or partially neutralize the fatty acids. The bases capable of being used to obtain the salts may be, for example, inorganic bases such as alkali metal hydroxides (sodium and potassium hydroxide), alkaline-earth metal hydroxides (magnesium hydroxide) or ammonium hydroxide, or else organic bases such as triethanolamine, N-methylglucamine, lysine and arginine. The fatty acid may be chosen, in particular, from C₁₀ to C₂₄, and especially C₁₂-C₁₈, fatty acids, and in particular lauric acid, myrisitic acid, stearic acid, palmitic acid and mixtures thereof.

The soap is generally introduced into a second composition in the form of the base, on the one hand, and of the fatty acid, on the other hand, the formation of the salt being carried out in situ.

4) As amino acid derivatives, mention may especially be made of the alkali metal salts of amino acids, such as:
sarcosinates, such as sodium lauroyl sarcosinate sold under the name SARKOSYL NL 97® by Ciba or sold under the name ORAMIX L 30® by SEPPIC, sodium myristoyl sarcosinate sold under the name NIKKOL SARCOSINATE MN® by Nikkol, sodium palmitoyl sarcosinate sold under the name NIKKOL SARCOSINATE PN® by Nikkol;
alaninates, such as sodium N-lauroyl-N-methylamidopropionate sold under the name SODIUM NIKKOL ALANINATE LN 30® by Nikkol, or sold under the name ALANONE ALE® by Kawaken, triethanolamine N-lauroyl-N-methylalanine sold under the name ALANONE ALTA® by Kawaken;
glutamates, such as triethanolamine monococoyl glutamate sold under the name ACYLGLUTAMATE CT-12® by Ajinomoto, triethanolamine lauroyl glutamate sold under the name ACYLGLUTAMATE LT-12® by Ajinomoto;
aspartates, such as the mixture of triethanolamine N-lauroylaspartate/tri-ethanolamine N-myristoylaspartate sold under the name ASPARACK® by Mitsubishi;
derivatives of glycine (glycinates), such as sodium N-cocoylglycinate sold under the names AMILITE GCS-12® and AMILITE GCK 12 by Ajinomoto;
citrates, such as the citric monoester of oxyethylenated (9 mol) coco alcohols, sold under the name WITCONOL EC 1129 by Goldschmidt; and galacturonates, such as sodium dodecyl d-galactoside uronate sold by Soliance.

5) As sulfosuccinates, mention may be made, for example of oxyethylenated (3 EO) lauryl alcohol monosulfosuccinate (70/30 C₁₂/C₁₄) sold under the names SETACIN 103 SPECIAL®, REWOPOL SB-FA 30 K 4® by Witco, the disodium salt of a C₁₂-C₁₄ alcohol hemisulfosuccinate sold under the name SETACIN F SPECIAL PASTE® by Zschimmer Schwarz, oxyethylenated (2 EO) disodium oleamidosulfosuccinate sold under the name STANDAPOL SH 135® by Cognis, oxyethylenated (5 EO) laurylamide mono-sulfosuccinate sold under the name LEBON A-5000® by Sanyo, the oxyethylenated (10 EO) disodium salt of lauryl citrate monosulfosuccinate sold under the name REWOPOL SB CS 50® by Witco, the ricinoleic monoethanolamide monosulfosuccinate sold under the name REWODERM S 1333® by Witco. It is also possible to use polydimethylsiloxane sulfosuccinates such as the disodium PEG-12 dimethicone sulfosuccinate sold under the name MACKANATE-DC30 by Mac Intyre.

6) As alkyl sulfates, mention may be made, for example, of triethanolamine lauryl sulfate (INCI name: TEA lauryl sulfate) such as the product sold by Huntsman under the name EMPICOL TL40 FL or that sold by Cognis under the name TEXAPON T42, products which are at a concentration of 40% in aqueous solution. Mention may also be made of ammonium lauryl sulfate (CFTA name: Ammonium lauryl sulfate) such as the product sold by Huntsman under the name EMPICOL AL 30FL which is at a concentration of 30% in aqueous solution.

7) As alkyl ether sulfates, mention may be made, for example, of sodium lauryl ether sulfate (INCI name: sodium laureth sulfate) such as that sold under the names TEXAPON N40 and TEXAPON AOSk 225 UP by Cognis or such as that sold under the name EMPICOL ESB 3/FL3 by Huntsman, ammonium lauryl ether sulfate (INCI name: ammonium laureth sulfate) such as that sold under the name STANDAPOL EA-2 by Cognis.

8) As sulfonates, mention may be made, for example, of α-olefin sulfonates such as sodium α-olefin (C₁₄₋₁₆) sulfonate sold under the name BIO-TERGE AS-40® by Stepan, sold under the names WITCONATE AOS PROTEGE® and SULFRAMINE AOS PH 12® by Witco or sold under the name BIO-TERGE AS-40 CG® by Stepan, the sodium secondary olefin sulfonate sold under the name HOSTAPUR SAS 30® by Clariant; linear alkyl aryl sulfonates such as sodium xylene sulfonate sold under the names MANROSOL SXS30′, MANROSOL SXS40®, MANROSOL SXS93® by Manro.

9) As isethionates, mention may be made of acyl isethionates such as sodium cocoyl isethionate, for instance the product sold under the name JORDAPON CI P® by Jordan.

10) As taurates, mention may be made of the sodium salt of palm kernel oil methyltaurate sold under the name HOSTAPON CT PATE® by Clariant; N-acyl N-methyltaurates such as sodium N-cocoyl N-methyltaurate sold under the name HOSTAPON LT-SF® by Clariant or sold under the name NIKKOL CMT-30-T® by Nikkol, sodium palmitoyl methyltaurate sold under the name NIKKOL PMT® by Nikkol.

11) The anionic derivatives of alkyl polyglucosides may especially be glycerol citrates, tartrates, sulfosuccinates, carbonates and ethers obtained from alkyl polyglucosides. Mention may be made, for example, of the sodium salt of cocoylpolyglucoside (1,4) tartaric ester, sold under the name EUCAROL AGE-ET® by Cesalpinia, the disodium salt of cocoylpolyglucoside (1,4) sulfosuccinic ester, sold under the name ESSAI 512 MP® by SEPPIC, the sodium salt of cocoyl polyglucoside (1,4) citric ester sold under the name EUCAROL AGE-EC® by Cesalpinia.

Amphoteric and Zwitterionic Foaming Surfactants

The amphoteric and zwitterionic surfactants may be chosen, for example, from betaines, N-alkylamido betaines and derivatives thereof, sultaines, alkyl polyaminocarboxylates, alkylamphoacetates and mixtures thereof

1) As betaines, mention may especially be made of alkyl betaines such as, for example, coco betaine, for instance the product sold under the name DEHYTON AB-30® by Cognis, lauryl betaine such as the product sold under the name GENAGEN KB® by Clariant, oxyethylenated (10 EO) lauryl betaine, such as the product sold under the name LAURYLETHER (10 EO) BETAINE® by Shin Nihon Rica, oxyethylenated (10 EO) stearyl betaine, such as the product sold under the name STEARYLETHER (10 EO) BETAINE® by Shin Nihon Rica.

Among the N-alkylamido betaines and derivatives thereof, mention may be made, for example, of the cocamidopropyl betaine sold under the name LEBON 2000 HG® by Sanyo, or sold under the name EMPIGEN BB® by Albright & Wilson, the lauramidopropyl betaine sold under the name REWOTERIC AMB12P® by Witco.

2) As sultaines, mention may be made of hydroxysultaines, such as cocamidopropyl hydroxysultaine for instance the product sold under the name REWOTERIC AM CAS by Goldschmidt-Degussa, or the product sold under the name CROSULTAINE C-50® by Croda.

3) As alkyl polyaminocarboxylates (APAC), mention may be made of sodium cocoyl polyaminocarboxylate, sold under the name AMPHOLAK 7 CX/C® and AMPHOLAK 7 CX® by Akzo Nobel, sodium stearyl polyamidocarboxylate sold under the name AMPHOLAK 7 TX/C by Akzo Nobel, sodium carboxymethyloleyl polypropylamine sold under the name AMPHOLAK X07/C® by Akzo Nobel.

4) As alkylamphoacetates, mention may be made, for example, of N-disodium N-cocoyl-N-carboxymethoxyethyl-N-carboxymethylethylenediamine (INCI name: disodium cocoamphodiacetate) such as the product sold under the name MIRANOL C2M CONCENTRE NP® by Rhodia, N-sodium N-cocoyl-N-hydroxyethyl-N-carboxymethylethylenediamine (INCI name: sodium cocoamphoacetate), sodium cocoamphohydroxypropyl sulfonate sold under the name MIRANOL CSE by Rhodia.

The foaming gel used as the second composition B according to the invention comprises at least 0.5% by weight, and preferably at least 10% by weight, of foaming surfactant(s) relative to the total weight of the second composition. Thus, the foaming surfactants (nonionic, anionic, amphoteric and zwitterionic) may be present in an amount (of active material) that ranges, for example, from 0.5 to 60% by weight, especially from 0.5 to 20% by weight, preferably from 1 to 15% by weight and better still from 2 to 10% by weight relative to the total weight of the second composition.

They may more particularly be present in an amount (of active material) that ranges, for example, from 10 to 60% by weight, especially from 15 to 60% by weight, for example from 20 to 60%, especially from 25 to 55% by weight, preferably from 30 to 50% by weight relative to the total weight of the second composition.

When the first composition A contains foaming surfactants, these may also be in the amounts indicated above.

According to one particular embodiment of the invention, composition B contains at least one nonionic foaming surfactant and, as a foaming surfactant other than the nonionic surfactant, at least one anionic surfactant and in particular an anionic derivative of proteins of vegetable origin or of silk proteins.

According to another more particular embodiment of the invention, composition B of the invention contains at least one alkyl polyglucoside and at least one anionic derivative of proteins of vegetable origin or of silk proteins.

Viscosity of the Compositions Forming a Product According to the Invention

As specified previously, the two compositions A and B forming the product according to the invention advantageously have the same viscosity.

Thus, the viscosity of the compositions of the invention is preferably greater than 2 Pa·s, more particularly greater than 3 Pa·s. Preferably, it is less than 20 Pa·s, in particular less than 15 Pa·s.

By way of example, this viscosity may vary from 2 to 15 Pa·s, preferably from 3 to 10 Pa·s and better still from 3 to 7 Pa·s.

The viscosity of the compositions is measured at ambient temperature (from 20 to 25° C.) and at ambient pressure, using a Rheomat 180 (Mettler) with a measurement body at 200 rpm.

This viscosity is particularly advantageous in terms of preemption and handling of the mixture of the two compositions.

For obvious reasons, this viscosity may need to be adjusted in each of the compositions that form the product according to the invention by means of compound(s) devoted, more particularly, to procuring a thickening effect.

By way of illustration of these compounds having a thickening nature, mention may more particularly be made of thickening polymeric compounds.

For obvious reasons, the choice of these polymers is conditioned by the chemical nature of each of the compositions in question.

Thus, in the case of compositions having an oily nature, as the compositions A known as “first compositions”, the use of anionic polymers such as defined below is preferred. On the other hand, in the case of compositions B known as “second compositions” which are of aqueous nature, oxyalkylenated nonionic polymers and cationic and amphoteric polymers such as defined below prove to be more particularly advantageous.

The first composition A may comprise from 0.5 to 4% by weight, in particular from 0.8 to 3% by weight of thickening polymer(s).

The second composition B may comprise from 0.5 to 5% by weight, in particular from 2 to 4% by weight of thickening polymer(s).

Oxyalkylenated Nonionic Polymers

These are compounds comprising at least one group chosen from ethylene oxide (EO) groups, propylene oxide (PO) groups and mixtures thereof (EO/PO). The compounds may therefore be oxyethylenated compounds, oxypropylenated compounds, or oxyethylenated/oxypropylenated compounds. These compounds are not surfactants but they have thickening properties and have a higher number of oxyethylenated and/or oxypropylenated units, in particular a number greater than 350.

The nonionic oxyalkylenated compounds may be chosen, in particular, from polyethylene glycols, esters of a fatty acid and polyethylene glycol and/or polypropylene glycol, alkyl-alkoxylated or acyl-alkoxylated derivatives, especially of polyol, oxyalkylenated, and especially oxyethylenated, glycerol and fatty acid triesters, oxyethylenated or oxypropylenated fatty amide derivatives, oxyethylenated urethane derivatives modified by alkyl chains, and mixtures thereof.

1. The polyethylene glycols which may be used in the composition of the invention are ethylene oxide polycondensates. Preferably, these polyethylene glycols have a number of ethylene oxide (EO) units greater than 1000. The ethylene oxide number may range, for example, from 1000 to 50 000, and preferably from 5000 to 10 000. As polyethylene glycols, mention may be made, for example, of the polyethylene glycol comprising 7000 EO (INCI name: PEG-7M) such as the product sold under the name POLYOX WSR N-750® by Amerchol, the polyethylene glycol comprising 14 000 EO (INCI name: PEG-14M) such as the product sold under the name POLYOX WSR 205 by Amerchol, the polyethylene glycol comprising 20 000 EO (INCI name: PEG-20M) such as the product sold under the name POLYOX WSR 1105® by Amerchol.

2. The esters of fatty acids and of polyethylene glycol and/or polypropylene glycol are condensates of polyethylene glycol and/or polypropylene glycol with one or more fatty acids. These are compounds of formula (II):

RCOO-(EO)ₘ-(PO)ₙ—R′ (II)

in which 0≦m≦300 and 0≦n≦300 and m+n>25, preferably >50, R and R′ represent, independently of one another, hydrogen or a saturated or unsaturated, linear or branched, hydroxylated or non-hydroxylated alkyl chain, comprising from 1 to 30 carbon atoms and preferably from 12 to 22 carbon atoms, or an aryl chain, on condition that R and R′ are not hydrogen at the same time.

As esters of fatty acids and of polyethylene glycol and/or polypropylene glycol, mention may be made, for example, of polyethylene glycol (150 EO) distearate such as the product sold under the name ATLAS G-1821® by Uniqema, PEG-150 dibehenate such as the product sold under the name ETHOX PEG 6000 Dibehenate® by Ethox, polyethylene glycol (120 EO) palmitostearate such as the product sold under the name STEARATE 6000 WL 1644® by Gattefosse, the polyethylene glycol (30 EO)/12-hydroxystearic acid copolymer such as the product sold under the name ARLACEL P135® by Uniqema, polyethylene glycol (40 EO) stearate such as the product sold under the name MYRJ 52® by Uniqema.

In the case where, in the formula (II), R═R′═H, mention may be made, for example, of the random polyoxyethylene/polyoxypropylene (17 EO/6 PO) copolymer sold under the reference UCON 75-H-450® by Amerchol. Molecules comprising more EO units and/or more PO units are not excluded.

3. The alkoxylated alkyl or acyl polyol derivatives may especially be ethoxylated alkyl or acyl polyol derivatives, for example oxyethylenated derivatives of fatty acid and polyol esters or oxyethylenated derivatives of fatty alcohol and polyol ethers, and especially oxyethylenated derivatives of esters of fatty acids or ethers of fatty alcohols and glycerol or sorbitol or glucose or pentaerythritol.

As derivatives of this type, mention may be made, for example, of oxyethylenated (78 EO) glyceryl cocoate such as the product sold under the name SIMULSOL CG by Seppic, oxyethylenated (120 EO) methyl glucose dioleate (INCI name: PEG-120 methylglucose dioleate) such as the product sold under the name GLUCAMATE DOE-120 VEGETAL® by Amerchol, oxyethylenated (40 EO) sorbitan septaoleate such as the product sold under the name ARLATONE T® by Uniqema, oxyethylenated (10 EO) polyglyceryl (2 moles of glycerol) laurate such as the product sold under the name HOE S 3495® by Clariant, oxyethylenated (60 EO) glyceryl isostearate such as the product sold under the name EMALEX GWIS-160® by SACI-CFPA, oxyethylenated (20 EO) glyceryl monostearate such as the product sold under the name CUTINA E 24® by Cognis, oxyethylenated (200 EO) glyceryl stearate such as the product sold under the name SIMULSOL 220 TM® by Seppic, oxyethylenated (150 EO) pentaerythrityl tetrastearate such as the product sold under the name CROTHIX® by Croda, oxyethylenated (160 EO) sorbitan tristearate such as the product sold under the name RHEODOL TW IS399C by Kao Chemicals.

4. As oxyethylenated triesters of glycerol and of fatty acids, mention may be made, for example of oxyethylenated (6 EO) caprylic/capric acid glycerides, such as the product sold under the name SOFTIGEN 767® by Condea, and oxyethylenated (50 EO) olive oil, such as the product sold under the name CROVOL O-70® by Croda.

5. As oxyalkylenated derivatives of fatty acid amides, mention may especially be made of oxypropylenated fatty acid amides such as, for example, PPG-2 hydroxyethyl cocamide and mixtures containing it such as the products sold by Uniqema under the name Promidium, especially Promidium CO.

6. As oxyethylenated urethane derivatives modified by alkyl chains, mention may be made, for example, of those of formulae (III) and (IV):

R₁NH—CO—(OCH₂CH₂)ₐ—[O—CO—NR₄—R₃—NR₄—CO—(OCH₂CH₂)ₐ]_{b}—O—CO—NHR₂ (III)

R₅—(OCH₂CH₂)ₙ—O—CO—NH—R₆—NH—CO—(OCH₂CH₂)ₙ—OR₅ (IV)

in which the R₁, R₂ and R₅ radicals represent a C₁₋₁₈ alkyl group; R₃ and R₆ represent a linear, cyclic or aromatic C₄₋₃₆ hydrocarbon-based radical; R₄ represents a hydrogen atom or a C₁₋₆ alkyl radical, preferably a hydrogen atom; a and n are integers ranging from 90 to 600, and b is an integer ranging from 1 to 4.

These are, for example, water-soluble polymers obtained by an addition reaction of diisocyanates (HMDI: Hexamethylene diisocyanate) to diols (polyether or polyester diols) that are terminated by hydrophobic groups that originate from ethoxylated or ethoxylated/propoxylated fatty alcohols. This is the case, for example, for NUVIS FX 1100, sold by Elementis, which is an oxyethylenated (100 EO) stearyl alcohol/polyethylene glycol (136 EO)/hexamethylene diisocyanate copolymer (INCI name: steareth-100/PEG-136/HMDI copolymer).

As nonionic polymers, use is preferably made of those chosen from oxyethylenated alkyl or acyl derivatives of esters of fatty acids or ethers of fatty alcohols and polyol, especially oxyethylenated derivatives of esters of fatty acids or ethers of fatty alcohols and glycerol or sorbitol or glucose or pentaerythritol, more particularly the oxyethylenated (120 EO) methyl glucose dioleate (INCI name: PEG-120 methylglucose dioleate).

Cationic and Amphoteric Polymers

As cationic or amphoteric polymers, mention may especially be made of those of the polyquaternium (INCI name) type, which provide softness and creaminess to the foaming cream. These polymers may preferably be chosen from the following polymers:
Polyquaternium 5 such as the product MERQUAT 5 sold by Calgon;
Polyquaternium 6 such as the product SALCARE SC 30 sold by Ciba, and the product MERQUAT 100 sold by Calgon;
Polyquaternium 7 such as the products MERQUAT S, MERQUAT 2200 and MERQUAT 550 sold by Calgon, and the product SALCARE SC 10 sold by Ciba;
Polyquaternium 10 such as the product Polymer JR400 sold by Amerchol;
Polyquaternium 11 such as the products GAFQUAT 755, GAFQUAT 755N and GAFQUAT 734 sold by ISP;
Polyquaternium 15 such as the product ROHAGIT KF 720 F sold by Rohm;
Polyquaternium 16 such as the products LUVIQUAT FC905, LUVIQUAT FC370, LUVIQUAT HM552 and LUVIQUAT FC550 sold by BASF;
Polyquaternium 22 such as the product MERQUAT 280 sold by Calgon;
Polyquaternium 28 such as the product STYLEZE CC10 sold by ISP;
Polyquaternium 39 such as the product MERQUAT PLUS 3330 sold by Calgon;
Polyquaternium 44 such as the product LUVIQUAT CARE sold by BASF;
Polyquaternium 46 such as the product LUVIQUAT HOLD sold by BASF;
Polyquaternium 47 such as the product MERQUAT 2001 sold by Calgon.

As a cationic polymer it is also possible to use cationic guar gums such as the JAGUAR products sold by Rhodia.

As cationic polymers, use is preferably made of Polyquaternium 7, Polyquaternium 14 and Polyquaternium 47.

Anionic Polymers

As anionic polymers, mention may especially be made of those comprising at least one hydrophobic chain, and in particular those derived from acrylic or methacrylic acid, such as the acrylates/steareth-20 methacrylate copolymer sold under the name ACULYN 22 by Rohm & Haas (INCI name: Acrylates/Steareth-30 Methacrylate copolymer); the (meth)acrylic acid/ethyl acrylate/oxyethylenated (25 EO) behenyl methacrylate terpolymer, as an aqueous emulsion sold under the name ACULYN 28 by Rohm & Haas; the acrylic acid/oxyethylenated (20 EO) monocetyl itaconate copolymer, as a 30% aqueous dispersion sold under the name STRUCTURE 3001 by National Starch; the acrylic acid/oxyethylenated (20 EO) monostearyl itaconate copolymer as a 30% aqueous dispersion sold under the name STRUCTURE 2001 by National Starch; the copolymer of acrylates/acrylate modified by polyoxyethylenated (25 EO) C₁₂-C₂₄ alcohols, in the form of a latex containing 30-32% of copolymer, sold under the name SYNTHALEN W2000 by 3V SA, and also the copolymers sold under the names PEMULEN or CARBOPOL by Noveon, for instance the acrylate/C₁₀-C₃₀-alkyl acrylate copolymer such as the products PEMULEN TR1, PEMULEN TR2 or CARBOPOL 1382 (INCI name: Acrylates/C10-30 Alkyl acrylate Crosspolymer).

As anionic polymers, mention may also be made of the polymers and copolymers of 2-acrylamido-2-methylpropanesulfonic acid (AMPS) such as:
the crosslinked and neutralized homopolymer of 2-acrylamido-2-methyl-propanesulfonic acid, sold by Clariant under the trade name HOSTACERIN AMPS (INCI name: ammonium polyacryldimethyltauramide);
the crosslinked anionic copolymers of acrylamide or methacrylamide and 2-acrylamido-2-methylpropanesulfonic acid, especially those that are in the form of a W/O emulsion, such as those sold under the name SEPIGEL 305 by SEPPIC (INCI name: Polyacrylamide/C13-14 Isoparaffin/Laureth-7), under the name of SIMULGEL 600 by Seppic (INCI name: Acrylamide/Sodium acryloyldimethyltaurate copolymer/Isohexadecane/Polysorbate 80),
the copolymers of (meth)acrylic acid or (meth)acrylate and 2-acrylamido-2-methylpropanesulfonic acid, especially those that are in the form of a W/O emulsion, such as those sold under the name SIMULGEL NS by SEPPIC (sodium acrylamido-2-methylpropanesulfonate/hydroxyethyl acrylate copolymer as a 40% inverse emulsion in Polysorbate 60 and squalane) (INCI name: hydroxyethyl acrylate/sodium acryloyl-dimethyltaurate copolymer/squalane/polysorbate 60) or those sold under the name of SIMULGEL EG by SEPPIC (acrylic acid/acrylamido-2-methylpropanesulfonic acid copolymer in the sodium salt form as a 45% inverse emulsion in isohexadecane/water) (INCI name: Sodium Acrylate/Sodium acryloydimethyltaurate copolymer/Isohexadecane/Polysorbate 80),
copolymers of 2-acrylamido-2-methylpropanesulfonic acid and vinylpyrrolidone or vinylformamide, such as the products sold under the names ARISTOFLEX AVC by Clariant, and
hydrophobic modified AMPS polymers such as, in particular, the copolymer of AMPS and an ethoxylated C₁₂-C₁₄ alcohol methacrylate (non-crosslinked copolymer obtained from GENAPOL LA-070 and AMPS) (INCI name: Ammonium Acryloyldimethyltaurate/Laureth-7 Methacrylate Copolymer) sold under the name ARISTOFLEX LNC by Clariant, and the copolymer of AMPS and ethoxylated (250E) stearyl methacrylate (copolymer crosslinked by trimethylolpropane triacrylate, obtained from GENAPOL T-250 and AMPS) (INCI name: Ammonium Acryloyldimethyltaurate/Steareth-25 Methacrylate Crosspolymer) sold under the name ARISTOFLEX HMS by Clariant, and the copolymer of AMPS and a C₁₆-C₁₈ alcohol methacrylate comprising from 6 to 10 oxyethylenated groups, more particularly the copolymer of AMPS and methacrylic acid or a salt of methacrylic acid and oxyethylenated stearyl alcohol comprising 8 mol of ethylene oxide (GENAPOL T-080), such as that sold under the name ARISTOFLEX SNC by Clariant (INCI name: Ammonium Acryloyldimethyltaurate/Steareth-8 Methacrylate Copolymer).

It is also possible to use, in the composition containing oil, oil thickeners, such as, for example, modified clays such as modified magnesium silicate (BENTONE GEL VS38 by Rheox), hectorite modified by distearyl dimethyl ammonium chloride (INCI name: Disteardimonium hectorite) sold under the name BENTONE 38 CE by RHEOX; and such as semicrystalline polymers (homopolymers or copolymers) such as the homopolymers that result from the polymerization of a monomer having a crystallizable chain chosen from C₁₄-C₂₂ alkyl acrylates and C₁₄-C₂₂ alkyl methacrylates, such as, in particular, those sold under the names INTELIMER® by Landec, described in the brochure “Intelimer® polymers”, Landec IP22 (Rev. 4-97). Mention may more particularly be made of the stearyl acrylate homopolymer (INTELIMER IPA-13.1) (INCI name: Poly C10-30 alkyl acrylate), the behenyl acrylate homopolymer (INTELIMER IPA-13.6) (INCI name: Poly C10-30 alkyl acrylate).

Use may also be made of copolymers of C₁₄-C₂₂ alkyl acrylates or C₁₄-C₂₂ alkyl methacrylates especially with acrylic acid. As copolymers, mention may be made of the copolymers obtained by copolymerization of behenyl acrylate and acrylic acid, or the copolymers obtained by the copolymerization of stearyl acrylate and acrylic acid.

As anionic polymers, use is preferably made of the polymers and copolymers of AMPS, in particular the crosslinked anionic copolymers of acrylamide or methacrylamide and 2-acrylamido-2-methylpropanesulfonic acid, that are in the form of a W/O emulsion, such as SIMULGEL 600 (INCI name: Acrylamide/Sodium acryloyldimethyltaurate copolymer/Isohexadecane/Polysorbate 80).

Physiologically Acceptable Medium

Within the meaning of the invention, a physiologically acceptable medium denotes a medium that is not toxic and is capable of being applied to the keratinous substances of humans and has a pleasant appearance, odor and feel.

As specified previously, the second composition contains at least, by way of a physiologically acceptable medium, water or an aqueous phase.

An aqueous phase contains water as a mixture with one or more water-soluble compounds.

In the case where the first composition is in the form of an emulsion, this also contains water or an aqueous phase.

The water preferably represents from 40 to 82% by weight, especially from 40 to 80% by weight, for example from 45 to 75% by weight, in particular from 50 to 70% by weight relative to the total weight of the second composition B.

Conversely, the water or the aqueous phase preferably represent less than 40% by weight, in particular less than 30% by weight, better still less than 25% by weight, for example less than 20% by weight and preferably less than 15% by weight relative to the total weight of the first composition A.

Generally, the term “water” is understood to mean pure or demineralized water.

However, some of the water used in the compositions of the invention may optionally be chosen from mineral or thermal water.

The expression “mineral or thermal water” denotes not only natural mineral or thermal water, but also natural mineral or thermal water enriched with additional mineral constituents and/or trace elements, and also aqueous solutions of minerals and/or trace elements prepared from purified, demineralized or distilled water.

A natural thermal or mineral water used according to the invention may, for example, be chosen from water from Vittel, water from the Vichy basin, water from Uriage, water from la Roche Posay, water from Bourboule, water from Enghien-les-Bains, water from Saint Gervais-les-Bains, water from Neris-les-Bains, water from Allevard-les-Bains, water from Digne, water from Maizieres, water from Neyrac-les-Bains, water from Lons-le-Saunier, water from Eaux Bonnes, water from Rochefort, water from Saint Christau, water from Fumades and water from Tercis-les-Bains, water from Uriagle-les-bains, water from Avene.

The physiologically acceptable media that form the compositions of the invention may, in addition, contain adjuvants that are customary in the cosmetic or dermatological field, such as hydrophilic or lipophilic gelling agents, hydrophilic or lipophilic active agents, preservatives (for example, phenoxyethanol and parabens), antioxidants, solvents, fragrances, fillers, UV sunscreens, bactericides, odor absorbers, dyestuffs, and salts.

The amounts of these various adjuvants are those conventionally used in the field in question and are, for example, from 0.01 to 20% of the total weight of the composition containing them. These adjuvants, depending on their nature, may be introduced into one or other of the compositions forming the product according to the invention.

As fillers which may be used in one and/or the other of the compositions of the invention, mention may be made, for example, besides pigments, of silica powder; talc; polyamide particles and especially those sold under the name ORGASOL by Atochem; polyethylene powders; powders of natural organic materials such as starch powders, especially the powders of maize, wheat or rice starch, crosslinked or uncrosslinked, such as the starch powders crosslinked by octenyl succinate anhydride, sold under the name DRY-FLO by National Starch; microspheres based on acrylic copolymers, such as those made of ethylene glycol dimethacrylate/lauryl methacrylate copolymer sold by Dow Corning under the name POLYTRAP; expanded powders such as hollow microspheres and, in particular, the microspheres sold under the name EXPANCEL by Kemanord Plast or under the name MICROPEARL F 80 ED by Matsumoto; silicone resin microbeads such as those sold under the name TOSPEARL by Toshiba Silicone; and mixtures thereof.

These fillers may be present in amounts ranging from 0 to 20% by weight and preferably from 1 to 10% by weight relative to the total weight of the composition containing them.

According to one particularly advantageous embodiment, the products according to the invention may additionally comprise exfoliating agents.

As exfoliating agents, mention may be made, for example, of exfoliating or scrubbing particles of mineral, vegetable or organic origin. Thus, it is possible to use, for example, polyethylene beads or powder, nylon powder, polyvinyl chloride powder, pumice, ground products of apricot kernels or of nut shells, sawdust, glass beads, alumina and mixtures thereof.

These particles may be present in an amount ranging, for example, from 0.5 to 40% by weight, preferably from 1 to 20% by weight and better still from 1 to 10% by weight relative to the total weight of the composition containing them.

When at least one of the compositions that forms the product according to the invention contains exfoliating particles, the latter may especially form a product for scrubbing the skin of the face or of the body.

As active agents that can be used in the products of the invention, mention may be made, for example, of water-soluble or fat-soluble vitamins such as vitamin A (retinol), vitamin E (tocopherol), vitamin C (ascorbic acid) and its derivatives such as ascorbyl glucoside, vitamin B5 (panthenol), vitamin B3 (niacinamide), derivatives (especially esters) of these vitamins and mixtures thereof; antiseptics; antibacterial active agents such as 2,4,4′-trichloro-2′-hydroxydiphenyl ether (or triclosan), 3,4,4′-trichlorocarbanilide (or triclocarban); antiseborrheic agents; antimicrobial agents such as benzoyl peroxide, salicylic acid, azelaic acid and niacin (vit. PP); slimming agents such as caffeine; optical brighteners, and any active agent suitable for the final objective of the composition, and mixtures thereof.

The choice of these active agents is adjusted as a function of the quality reserved for the product according to the invention, for example salicylic acid, azelaic acid, triclosan, piroctone olamine and niacinamide (vitamin PP) for the treatment of oily skin.

Packaging Unit

As specified previously, the invention also relates to a packaging unit.

More particularly, this unit comprises at least:

i. a first compartment containing a first composition comprising a physiologically acceptable medium, at least 50% by weight of at least one oil relative to the total weight of said composition;

ii. a second compartment containing a second composition that is in the form of an aqueous gel and that contains at least one foaming surfactant, said second compartment being isolated from the first in a leaktight manner; and

iii. means for allowing the two compositions to come into contact, especially extemporaneously.

Such a unit advantageously enables its two compositions, packaged separately in the first and second compartments respectively that form said unit, to be brought into contact extemporaneously.

This unit may also be equipped with means that enable the first and second compartments, and therefore their respective contents, to be connected.

The unit is also advantageously equipped with a means suitable for dispensing the mixture of the two compositions.

More specifically, the compositions A and B used for implementing the invention are packaged separately inside two compartments, formed either from two separate containers, or inside a single device.

The term “single device” is understood to mean a device for which the two compartments are securely fastened to one another. Such a device may be obtained by a process of one-piece molding of the two compartments, especially from a thermoplastic. It may also result from any form of assembly, especially by bonding, welding or else snap-fastening.

According to a first embodiment, the two containers are independent of one another. Such containers may be in various forms. They may especially be tubes, bottles or cans.

One and/or the other of the containers may be surmounted by a manually-activated pump that is topped with a pushbutton for activating the pump and dispensing the composition via at least one dispensing orifice.

Alternatively, one and/or the other of the containers are pressurized, especially by means of a propellant, in particular a propellant gas. In this case, the container(s) is (are) equipped with a valve topped by a pushbutton equipped with a nozzle or any other dispersal means for dispensing the product.

The propellant may be mixed with the composition to be dispensed or may be separate from it, in particular via a piston capable of sliding inside the container, or via flexible walls of a pouch inside which the composition is placed.

The containers may be formed from various materials: plastic, glass or metal.

According to one preferred embodiment, the two compositions are contained inside a single device.

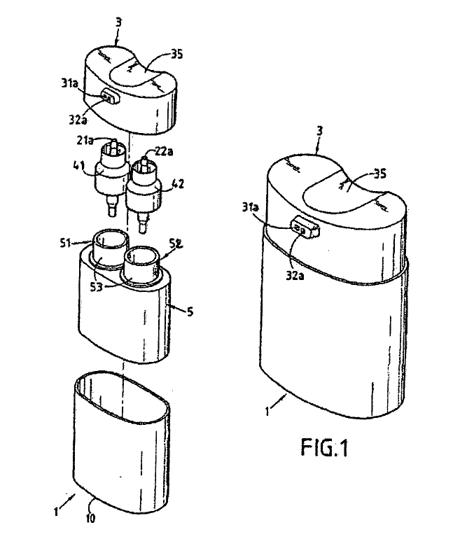

According to the embodiment represented in FIG. 1, the packaging device 1 is composed of two compartments 51, 52 positioned side by side and formed inside a part 5 obtained by molding a thermoplastic. Each of the containers 51, 52 comprises a neck 53 delimiting an opening. Mounted inside the neck of each of the containers is a pump 41, 42 which may or may not have an air return.

During the assembly, the part 5 delimiting the two compartments 51, 52 is positioned inside a covering element 10.

A pump rod 21a, 22a of each of the pumps 41, 42 is inevitably inserted inside a corresponding conduit provided in a single pushbutton 3 configured so as to allow the simultaneous activation of both pumps, in response to a pressure exerted axially on a surface 35 of the pushbutton 3.

The conduits of the pushbutton connected to each of the pumps open into two orifices 31a, 32a, positioned in the vicinity of one another on an outer surface of the pushbutton 3. In response to activation of the pumps 41, 42, the two compositions come out separately either onto the user's finger, or onto a pad or cotton applicator. The mixing of the two compositions is then carried out during the application to the surface to be treated.

According to another embodiment that is not illustrated, the two containers are pressurized and equipped with a valve that operates by being depressed or tilted. The two valves can preferably be activated by one and the same pushbutton of the type of that described with reference to the pump embodiment.

Alternatively still, the two compartments are formed from two concentric compartments formed inside a tube, and where appropriate are surmounted by a pump, without an air return, equipped with a pushbutton having one or two dispensing orifices. Provided inside the tube may be a piston which gradually climbs in the direction of the pump as the compositions are removed from inside the containers. Such dispensing modes are especially used for dispensing toothpaste.

Other devices still may be used for implementing the present invention, the main thing being that they can enable the two compositions to be packaged separately and to be dispensed separately or as a mixture.

As a further example, the two compositions are packaged inside two compartments formed inside one and the same flexible sachet, the two compartments being separated by a rupture zone which may be broken at the moment of use, especially in response to a pressure exerted at a precise location on the sachet.

The invention therefore relates, in particular, to a unit, in which the compositions A and B are packaged inside two compartments formed from two separate containers.

According to one particular mode, the compositions A and B are packaged inside two compartments (51, 52) delimited by a single device (1) such as represented in FIG. 1.

In particular, each of the compartments is equipped with a pump (41, 42), preferably that can be activated manually, connected to at least one actuating and dispensing means (3) that makes it possible to deliver the compositions A and B separately or as a mixture.

According to a preferred mode, the actuating and dispensing means (3) is common to both pumps.

According to one alternative, each of the compartments is pressurized, especially by means of a propellant, and equipped with a valve connected to at least one actuating and dispensing means that makes it possible to deliver the compositions A and B separately or as a mixture.

In particular, the actuating and dispensing means is common to both valves.

It is possible to use, for example, devices such as described in documents U.S. Pat. No. 5,833,121, U.S. Pat. No. 4,773,562 and U.S. Pat. No. 6,672,483.

A unit or a product according to the invention is more particularly intended for a cosmetic application of the cleansing and/or makeup-removing type.

The products according to the invention may especially form products for cleansing or removing makeup from the skin (body, face, eyes), the scalp and/or the hair.

Another subject of the invention consists of the cosmetic use of a product such as defined above, as products for cleansing and/or removing makeup from the skin, scalp and/or hair.

The products according to the invention may together form a product for treating oily skin and/or disinfecting the skin and/or scalp, especially when they contain an antibacterial agent. In particular, the specific active agents for treating oily skin may be included therein, such as, for example, salicylic acid, azelaic acid, triclosan, piroctone olamine and niacinamide (vitamin PP).

Another subject of the invention consists of a cosmetic method for cleansing the skin, eyes, scalp and/or hair, characterized in that a mixture of the compositions forming the product according to the invention is applied to the skin, eyes, scalp and/or hair and the foam formed and the dirt residues are removed by rinsing with water.

In the case of cleaning the face, the product according to the invention may form a mask which is rinsed off after a leave-on time of 1 to 3 minutes.

The examples which follow serve to illustrate the invention without however having a limiting nature. The amounts indicated are in % by weight of raw material (and not of active material) except where mentioned otherwise.

### Example 1

First composition containing at least 50% oil

| | |
|---|---|
| Citric acid | 0.30% |
| Silica (AEROSOL 200 ® from Degussa-Hüls) | 2.00% |
| Ethylhexyl palmitate | 50.00% |
| Colorants | qs |
| Preservatives | 0.80% |
| Fragrances | 0.40% |
| Acrylamide/Sodium Acryloyldimethyltaurate Copolymer | 0.80% |
| (And) Isohexadecane (And) Polysorbate 80 | |
| (SIMULGEL 600 from SEPPIC) | |
| Polyquaternium 47 (MERQUAT 2001 from Nalco | 0.40% |
| at a concentration of 20% active material) | |
| Glycerol | 6.50% |
| Coco betaine (sold under the reference DEHYTON AB 30 | 9.00% |
| by Cognis at a concentration of 100% active material) | |
| Beheneth-10 (EUMULGIN BA10 from Cognis | 4.00% |
| at a concentration of 100% active material) | |
| Decyl glucoside (sold under the reference MYDOL 10 | 12.00% |
| by KAO at a concentration of 40% active material) | |
| Water | qs for |
| | 100.00% |

Procedure: The phase containing the beheneth-10, the glycerol, the preservatives, the oils and water was heated at 85° C. in a Rayneri mixer until all the preservatives had dissolved. The mixture thus obtained then became opaque. This phase was then cooled to 60° C. Then the mixture thickened. Next, the silica was introduced and the mixture became more fluid. After having been homogenized for several minutes, it was cooled to 45° C. Next the foaming surfactants (coco betaine, decyl glucoside) were introduced, then, at ambient temperature, the citric acid, colorants, fragrances and polymers were introduced.

### Example 2

First composition containing at least 50% oil

| | |
|---|---|
| Silica (AEROSOL 200 ® from Degussa-Hüls) | 1.00% |
| Ethylhexyl palmitate | 68.00% |
| Preservatives | 0.40% |
| Ethanol | 2.00% |
| Glycerol | 10.00% |
| Beheneth-10 (EUMULGIN BA 10 from Cognis | 5.00% |
| at a concentration of 100% active material) | |
| Water | qs for 100.0% |

Procedure: A phase containing the beheneth-10, the glycerol, the preservatives, the oils and water was first heated at 85° C. in a Rayneri mixer until all the preservatives had dissolved. The mixture thus obtained then became opaque. This phase was then cooled to 60° C. The mixture thickened. Next, the silica was introduced and the mixture became more fluid. After having been homogenized for several minutes, it was cooled to 45° C. The surfactants were introduced, then, at ambient temperature, the colorants, fragrances and polymers were introduced.

### Example 3

Second composition of aqueous gel type

| | |
|---|---|
| Disodium EDTA | 0.20% |
| Triethanolamine | 0.60% |
| Colorants | qs |
| Salicylic acid | 0.60% |
| Preservatives | 0.50% |
| Fragrances | 0.50% |
| Acrylates/Steareth-20 methacrylate copolymer | 3.00% |
| (ACULYN 22 POLYMER ® from Rohm & Haas) | |
| Butylene glycol | 3.00% |
| Triethanolamine lauryl sulfate (TEXAPON T 42 ® | 5.00% |
| from Cognis at a concentration of 40% active material) | |
| Decyl glucoside (MYDOL 10 ® | 2.00% |
| from KAO at a concentration of 40% active material) | |
| Sodium Lauroyl Oat Amino Acids (PROTEOL OAT ® | 4.00% |
| from SEPPIC at a concentration of 30% active material) | |
| Water | qs for 100.0% |

Procedure: The salicylic acid, butylene glycol and water were first mixed by heating until they had dissolved. When the temperature had returned to ambient temperature, the other compounds were added, introducing the fragrances, surfactants and polymers last.

### Example 4

Second composition of aqueous gel type

| | |
|---|---|
| Sodium citrate | 0.04% |
| Sorbitol | 3.50% |
| Preservatives | 0.45% |
| Fragrances | 0.20% |
| Glycerol | 3.50% |
| Coco betaine (DEHYTON AB 30 ® | 32.50% |
| from Cognis at a concentration of 100% active material) | |
| PEG-120 Methyl Glucose Dioleate (Glucamate DOE | 3.00% |
| 120 ® from Amerchol) | |
| Sodium laureth sulfate (EMPICOL ESB 3/FL3 ® | 3.70% |
| from Huntsman at a concentration of 70% active material) | |
| Ascorbyl glucoside | 0.05% |
| Water qs for | 100.00% |

Procedure: The PEG-120 methyl glucose dioleate, water, glycerol and preservatives were first mixed by heating until they had dissolved. When the temperature had returned to ambient temperature, the other compounds were added, introducing the ascorbyl glucoside and sodium citrate last.

### Example 5

Second composition of aqueous gel type

| | |
|---|---|
| Potassium hydroxide | 4.00% |
| Disodium EDTA | 0.20% |
| Sorbitol | 3.50% |
| Colorants | qs |
| Salicylic acid | 0.40% |
| Preservatives | 0.70% |
| Fragrances | 0.20% |
| Glycerol | 3.50% |
| Pentylene glycol | 0.10% |
| PEG-150 Distearate (Polyethylene glycol 6000 Distearate ® | 1.00% |
| from Akzo Nobel at a concentration of 100% active material) | |
| Decyl glucoside (Mydol 10 ® | 16.25% |
| from KAO at a concentration of 40% active material) | |
| PEG-150 Pentaerythrityl Tetrastearate (CROTHIX ® | 1.00% |
| from Croda at a concentration of 100% active material) | |
| Sodium Cocoyl Glycinate (AMILITE GCS 12 | 5.85% |
| from Ajinomoto at a concentration of 30% active material) | |
| Lauryl Phosphate (MAP 20 | 6.50% |
| from Kao at a concentration of 100% active material) | |
| PEG-200 Glyceryl Stearate (SIMULSOL 220 TM | 2.00% |
| from SEPPIC) | |
| Water | qs for |
| | 100.00% |

Procedure: The gelling agents (PEG-150 distearate, PEG-150 pentaerythrityl tetrastearate and PEG-200 glyceryl stearate), water, glycerol, preservatives, disodium EDTA, sorbitol, colorants and pentylene glycol were first mixed by heating until they had dissolved. The potassium hydroxide and lauryl phosphate were then added, then the other surfactants. When the temperature had returned to ambient temperature, the other compounds were added, introducing the fragrances last.

### Example 6 of a Product According to the Invention

The first composition from example 2 and the same amount of the second composition from example 3 were packaged in two separate compartments of a packaging having twin compartments of tube type.

The two compositions were mixed on exiting the tube in a 50/50 weight ratio with water.

The corresponding mixture was applied to the skin of a face made up with a film of makeup of the transfer-resistant foundation type. The makeup removal was carried out effectively and did not give any feeling of dryness. By way of comparison, the same makeup-removal operation was reproduced solely with the composition from example 1. The makeup removal thus obtained proved less effective than that obtained with the product according to the invention.

### Example 7

### Comparative

A product according to the invention was prepared by packaging the first composition from example 2 and the same amount of the second composition from example 4 in two separate compartments of a packaging unit of tube type.
By way of comparison, a product comprising a first composition A′ such as described below and a same amount of said second composition from example 4 was prepared in an analogous manner.

The composition A′ was the following:

| | |
|---|---|
| Silica (AEROSOL 200 ® from Degussa-Hüls) | 1.00% |
| Ethylhexyl palmitate | 68.00% |
| Preservatives | 0.40% |
| Ethanol | 2.00% |
| Glycerol | 10.00% |
| Mixture of glyceryl monostearate/distearate and PEG-100 | 5.00% |
| stearate (ARLACEL 165FI from Croda) | |
| Water | qs for 100.0% |

Procedure: Arlacel is mixed in oil and emulsion is prepared under heat at 65° C. by mixing the aqueous phase comprising glycerol, preservatives, silica, ethanol and water, with the oilg phase.

It was firstly observed that the first composition A′ hardly foamed in comparison with the first composition from example 2.

Moreover, it was also observed that the first composition A′ only slightly mixed with the second composition, contrary to the first composition of the product according to the invention.

The performances of these two products were then compared as follows.

For each of the products, the two compositions were mixed on exiting the tube in a 50/50 weight ratio with water.

The corresponding mixture was applied to the skin of a face made up with a film of makeup of the transfer-resistant foundation type.

The makeup removal obtained by using the comparative product proved less effective than that obtained with the product according to the invention.

The performances of the products were also tested in order to evaluate the makeup removal properties of the products on a long wear lipstick and a waterproof mascara.

It is stated that the comparative product hardly removes the makeup in comparison to the product according to the invention.

Unlike the comparative product, the product according to the invention abundantly and immediately foamed and allowed to easily and quickly remove the mascara and the lipstick films.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A cosmetic product for cleansing and/or removing makeup from keratinous substance(s) comprising, separately from one another, at least a first and a second cosmetic composition, and wherein:
the first composition A is in the form of an oil-in-water emulsion obtained according to the phase inversion temperature process according to PIT technology and comprises, in a physiologically acceptable medium, at least 50% by weight of at least one oil or oily phase, relative to the total weight of the first composition; and
the second composition B is in the form of an aqueous gel and comprises, in a physiologically acceptable medium, at least one foaming surfactant.

2. The product according to claim 1, wherein the first composition A comprises less than 40% by weight of water or of aqueous phase relative to the total weight of the first composition A3.

3. The product according to claim 1, wherein the first composition A comprises less than 25% by weight of water or of aqueous phase relative to the total weight of the first composition.

4. The product according to claim 1, wherein the first composition A comprises at least one emulsifier.

5. The product according to claim 4, wherein the emulsifier is chosen from ethoxylated fatty alcohols or ethoxylated fatty acids having the formulae (I) and (II) below:
R—O—(CH₂—CH₂—O)ₘH (I)
R—COO—(CH₂—CH₂—O)ₘH (II)
where R is a saturated or unsaturated, linear or branched hydrocarbon-based chain having from 10 to 24 carbon atoms, and m is an integer ranging from 8 to 50.

6. The product according to claim 1, wherein the second composition B comprises at least 0.5% by weight of foaming surfactant(s) relative to the total weight of the second composition.

7. The product according to claim 1, wherein the second composition B comprises from 0.5% to 60% by weight of foaming surfactant(s) relative to the total weight of the second composition.

8. The product according to claim 1, wherein the second composition B is in the form of a transparent aqueous gel.

9. The product according to claim 1, wherein the second composition B additionally comprises at least one polymer chosen among oxyalkylenated non ionic polymers, cationic polymers and amphoteric polymers.

10. The product according to claim 1, wherein the first and/or the second composition has a viscosity greater than 2 Pa·s.

11. The product according to claim 1, wherein it forms a cleansing, makeup-removing product, a scrubbing product or an exfoliating product.

12. A unit for packaging and dispensing compositions that form a product according to claim 1, said unit comprising at least two independent compartments that respectively comprise each of said compositions and that are adjusted for dispensing the two compositions separately or as a mixture.

13. A method for cleansing and/or removing makeup from keratinous substance(s) comprising at least the steps consisting in:
a) having a first composition A that comprises, in a physiologically acceptable medium, at least 50% by weight of at least one oil or oily phase relative to the total weight of said first composition;
b) having a second composition B that is in the form of an aqueous gel and that comprises, in a physiologically acceptable medium, at least one foaming surfactant;
c) bringing said first composition A into contact extemporaneously with said second composition B; and
d) applying the mixture obtained in the preceding step to said keratinous substance.

14. The method as claimed in claim 13, wherein the first and second compositions are such as defined in claim 1.

15. The method as claimed in claim 13, wherein the steps c) and d) are carried out simultaneously.

16. The method as claimed in claim 13, wherein step d) is carried out in the presence of water.

17. The method as claimed in claim 13, wherein step d) is followed by a step of rinsing the keratinous substance treated with water.
